(19) United States
(12) Patent Application Publication
(10) Pub. No.: US 2010/0170855 A1
(43) Pub. Date: Jul. 8, 2010

(54) MODIFICATION OF PRECIPITATE MORPHOLOGY AND SETTLING CHARACTERISTICS IN ACID CONDITIONS

(76) Inventors: Daniel N. T. Hay, Naperville, IL (US); Jasbir S. Gill, Naperville, IL (US)

Correspondence Address: NALCO COMPANY, 1601 W. DIEHL ROAD, NAPERVILLE, IL, 60563-1198, US

(21) Appl. No.: 12/349,320

(22) Filed: Jan. 6, 2009

(51) Int. Cl. B03D 3/00

(52) U.S. Cl. 210/726; 210/723

(57) ABSTRACT

The current invention relates to the modification of precipitate formed from an acidic slurry or solution resulting in decreased settling times and final solids bed volumes. The current invention uses an aqueous synthetic mixture comprising a phosphate, phosphonate, anionic polymer, anionic/cationic polymer blend or combinations thereof in the slurry and/or solution to improve clarification of the process stream. The claimed invention has a significant effect on precipitate morphology consequently improving settling characteristics and allowing for superior solid-liquid separation and process throughput.

### COPYRIGHT NOTICE

A portion of the disclosure of this patent document contains or may contain copyright protected material. The copyright owner has no objection to the photocopy reproduction by anyone of the patent document or the patent disclosure in exactly the form it appears in the Patent and Trademark Office patent file or records, but otherwise reserves all copyright rights whatsoever.

### TECHNICAL FIELD

This invention relates to improved clarification of the process stream in the acid production process. A modified precipitate is removed more quickly from acidic aqueous solutions by addition of synthetic aqueous mixtures containing organic phosphonates, organic phosphate derivatives, inorganic phosphates, anionic polymers and copolymers, anionic/cationic polymer blends, or a combination thereof.

### BACKGROUND

Phosphoric acid is generally produced from a crude phosphate containing ore that has been upgraded or beneficiated by washing, desliming, and flotation. The beneficiated material is then ground prior to digestion with sulfuric acid. Typically, to a slurry of beneficiated rock and recycled acid from the process, concentrated sulfurric acid is added at a rate to control the exotherm in a quantity ranging from 100 to 105% of the stoichiometric amount based on a calcium oxide calculation. After digestion is completed, the digested phosphate rock or acid slurry is subjected to the purification process, which includes a filtration step followed by evaporation of the acid stream and subsequent clarification steps to produce finished phosphoric acid. This is then converted into products ranging from fertilizer to detergent additives, animal feeds, phosphorous containing products used in the phosphatizing of steel, or any other purified phosphoric acid products.

One of the most challenging issues in the digestion of phosphate rock and in the evaporation of phosphoric acid is the precipitation of solids, which may be by-products. Precipitation predominantly occurs concurrently with the digestion phase of the acid production process, prior to the filtration step. Additionally, a certain amount occurs through evaporation as well as in additional clarification or purification steps throughout the process. The amount and timeliness of the settling or filtration of the precipitate is important in acid production because ultimately the process throughput is dependent on efficient removal of solids from the process stream.

Calcium sulfate is recognized as the primary ingredient of the precipitate generated from the digestion of phosphate rock in wet process phosphoric acid production. There are three different forms of calcium sulfate precipitated. These forms, Gypsum (CaSO₄.21H₂O), calcium sulfate Hemihydrate (CaSO₄.1/2H₂O), and calcium sulfate Anhydrite (CaSO₄) are dependent on temperature and the residence time within the process. This phase transformation adds to the complexity of their crystal modification and removal from the process stream.

The manufacture of phosphates and phosphoric acid is further detailed in the work by Becker, “Phosphates and Phosphoric Acid,” copyright 1989 by Marcel Dekker, Inc. and Slack, “Phosphoric Acid, Part I and Part II,” copyright 1968 by Marcel Dekker, Inc.

The present invention is predicated upon the discovery that certain water-soluble organic and inorganic phosphates, phosphonates, polycarboxylates and their homopolymers or copolymers, anionic/cationic polymer blends, and their mixtures (a clarification aid composition) are able to modify the morphology of precipitate and decrease the settling time as well as the final bed volume of the solids, thus improving solid-liquid separation.

The current invention relates to the improved clarification of the process stream in the purification process of the acid production system and is a method of altering the nature and improving settling characteristics of the precipitate produced from the digestion of phosphate rock and/or from the resulting phosphoric acid. This method comprises treating the process stream produced by the digestion of phosphate rock throughout the acid production process with a clarification aid at substoichiometric amounts. The preferred application point(s) of the clarification aid composition is prior to the filtration and/or clarification stages of the acid production process by adding the clarification aid to the process stream prior to or during precipitation. The clarification aid is typically added within a dosage range of 0.1-5000 ppm, preferably 0.1-100 ppm and most preferably 0.1-50 ppm, depending on solution composition, impurities, and process conditions.

Generally, the wet process production of phosphoric acid involves the digestion of a phosphate containing ore slurry with sulfuric acid. The resulting phosphoric acid is separated from precipitated calcium sulfate and other solid impurities by filtration. The phosphoric acid solution is then concentrated through evaporation and clarified to yield the finished phosphoric acid (˜50-70 % P₂O₅). Although much of the calcium sulfate and other impurities are removed during the filtration step, a significant amount remains dissolved in the process stream after filtration. As the phosphoric acid is concentrated through the evaporator circuit, or ages throughout the process, calcium sulfate of various forms as well as other materials continue to precipitate from solution resulting in solid formation. These solids precipitated throughout the production process must be removed from the acid stream. The morphology of these solids plays a significant role in their settling and filtration characteristics and ultimately in the clarification of the phosphoric acid stream. Certain crystal morphologies, such as fine needles or plates, can remain suspended in solution or blind filter media due to poor filter cake porosity. Solids that settle rapidly and generate compact but porous solids beds or filter cakes can allow for efficient solid-liquid separation and thus improved clarification of the acid stream and increased efficiency in the acid production process.

The addition of a clarification aid to a supersaturated calcium sulfate solution resulted in the alteration of solid precipitate morphology, relative to an untreated control. Solids precipitated in the presence of clarification aid tended to be more granular, crystalline, and free flowing compared to the feathery solids of the control tests, which formed entangled fibrous filter cakes. Microscopically, crystals from the clarification aid treated tests were generally larger and clustered compared to the fine needles from untreated control tests. This change in morphology resulted in a reduction of precipitate settling times by 41-47% and of final solids bed volumes by 55-90%, relative to the control. It was found that at high dosages the clarification aid acted as a precipitation inhibitor generating less solid precipitate from the supersaturated solution.

### Inorganic Phosphate:

Is comprised of a compound containing the phosphate moiety or phosphate units linked by phosphoanhydride bonds.

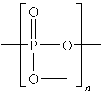

where n≧1

### Organic Phosphate:

Comprised of an ester of inorganic phosphate.

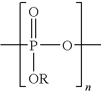

where R is alkyl or aryl and n≧1

### Phosphonate:

Comprised of a compound containing the structural moiety.

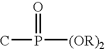

where R is H, alkyl or aryl

### Polycarboxylate:

Comprised of a polymer derived from monomers containing the carboxylic acid functional group or salts thereof selected, for example, from the group consisting of acrylic acid, methacrylic acid, α-haloacrylic acid, maleic acid or anhydride, vinylacetic acid, allylacetic acid, fuaric acid, and β-carboxyethylacrylate. Polycarboxylate copolymers can also incorporate, along with carboxy containing monomers, monomers containing the sulfonic acid group or salts thereof selected, for example, from the group consisting of 2-acrylamido-2-methylpropylsulfonic acid, 2-methacrylamido-2-methylpropylsulfonic acid, vinylsulfonic acid, sulfoalkyl acrylate, sulfoalkyl methacrylate, allylsulfonic acid, methallylsulfonic acid, and 3-methacrylamido-2-hydroxypropylsulfonic acid.

### Anionic/Cationic Polymer Mixture or Blend:

Comprised of an anionic polymer, or salt thereof, selected from polyacrylic acid, polymethacrylic acid, and polymaleic anhydride, each optionally copolymerized with each other, or optionally copolymerized with acrylamide up to a 1:1 molar ratio, combined with the polycation poly(dimethyldiallylammonium chloride) to form a polyelectrolyte complex.

### Homopolymer:

Comprised of a polymer derived from only one monomeric species.

### Copolymer:

Comprised of a polymer derived from two or more monomeric species (heteropolymer).

### Flocculant:

The molecular weight of a polymer flocculent can vary and usually ranges from less than about 250,000 to about 30, 000,000, or higher. Preferably the molecular weight ranges from about 10,000,000 to more than about 20,000,000, and most preferably from about 15,000,000 to about 20,000,000.

### SUMMARY

The current invention describes the following key aspects:
1. It is an advantage of the invention to modify the morphology of precipitate from the process stream prior to any clarification step.
2. It is an advantage of the invention to decrease the settling time of precipitated solids generated from the process stream, thus improving clarification.
3. It is an advantage of the invention to generate a more compact, lower volume, solids bed after settling.
4. It is an advantage of the invention to provide increased process throughput.

### DETAILED DESCRIPTION

The claimed invention relates to a process for modifying the morphology and improving solid-liquid separation of a precipitate in an acid production process comprised of an ore being combined with an acidic solution in a digestion process to react forming an acidic slurry which enters the purification process comprised of passing the acid slurry through a filtration process to form a filtrate which is then passed through an evaporation process and its step of heat exchange and a clarification process, wherein a clarification aid composition is added to the acid slurry and/or filtrate prior to or during the formation of a precipitate in the acid slurry and/or filtrate.

The process of the claimed invention a polymer flocculant is additionally added with a clarification aid composition wherein the polymer flocculant is in the form of a rapidly inverting emulsion added with no prior treatment to destabilize the emulsion.

The clarification aid composition used in the claimed process may be added to the filtrate immediately prior to entering and/or during the evaporation process, to the filtrate immediately prior to entering a heat exchangers and/or is added to the filtrate immediately prior to entering a heat exchangers.

The ore used in the claimed process maybe a phosphate containing ore that can be beneficiated prior to digestion. The said ore is combined with an acidic solution that can be is sulfuric acid.

The clarification aid composition can be one or a combination of an organic phosphate, a phosphonate, an inorganic phosphate, a polycarboxylate homopolymer or copolymer, an anionic/cationic polymer mixture. The clarification aid composition is added in substoichiometric amounts that can range from 0.1 to 5000 ppm preferable from 0.1 to 100 ppm and most preferable from 0.1 to 50 ppm.

An additional embodiment of the claimed invention which is a process for modifying the morphology and improving solid-liquid separation of a precipitate in an acid production process comprised of an ore being combined with an acidic solution in a digestion process to react forming an acidic slurry which enters the purification process comprised of passing the acid slurry through a filtration process to form a filtrate which is then passed through an evaporation process and its step of heat exchange and a clarification process, wherein a clarification aid composition is added during digestion. The invention wherein a polymer flocculant is additionally added with a clarification aid composition. The polymer flocculant is in the form of a rapidly inverting emulsion added with no prior treatment to destabilize the emulsion. The embodiment wherein the clarification aid composition is also added to the acid slurry and/or filtrate prior to or during the formation of a precipitate in the acid slurry and/or filtrate throughout the purification process.

The ore used in the current embodiment of the claimed process maybe a phosphate containing ore that can be beneficiated prior to digestion. The said ore is combined with an acidic solution that can be is sulfuric acid and the clarification aid composition can be one or a combination of an organic phosphate, a phosphonate, an inorganic phosphate, a polycarboxylate homopolymer or copolymer, an anionic/cationic polymer mixture.

### EXAMPLES

The foregoing may be better understood by reference to the following examples, which are intended to illustrate methods for carrying out the invention and are not intended to limit the scope of the invention.

A synthetic aqueous solution was prepared by dissolving an appropriate amount of calcium chloride and sodium sulfate in deionized water. The pH of the solution was adjusted to 2 using reagent grade phosphoric acid and maintained while deionized water was added to yield the desired final volume. 200 mL of this solution was transferred, by weight, into a stainless steel bottle. To the bottle, the appropriate amount of either clarification aid or an equivalent volume of water (control test) was added via syringe or pipette. The bottle was capped and the contents were mixed to homogenize. The test bottles were loaded into a rotating oil bath and heated at 85° C. for 1.5 hrs to induce precipitation of solid calcium sulfate. The bottles were then removed from the oil bath, cooled in an ambient temperature water bath, and the solids isolated via filtration. The solids were recovered and washed using methanol then dried under vacuum and weighed.

In a graduated cylinder, 100 mg of the recovered solid precipitate was suspended in 25 mL of filtered mother liquor from an untreated control test. The homogeneous mixture was allowed to settle. Settling time was noted as the time necessary to form a stable solids bed. The bed volume ratio is defined as the ratio of final bed height of the clarification aid treated sample to the final bed height of the corresponding untreated control test.

TABLE 1

| | | | Settling Time, | |
|---|---|---|---|---|
| | Dosage, mg/L | Precipitate Mass, mg | sec | |
| Control | 0 | 691.5 | 255 | |
| Additive A | 5 | 675.4 | 150 | |
| | | % Change, | % Reduction, | Bed Volume |
| | Relative to Control | Precipitate Mass | Settling Time | Ratio |
| | 5 mg/L Additive A | −2.3 | 41 | 0.45 |
| Control | 0 | 704.4 | 285 | |
| Additive A | 10 | 658.7 | 150 | |
| | | % Change, | % Reduction, | Bed Volume |
| | Relative to Control | Precipitate Mass | Settling Time | Ratio |
| | 10 mg/L Additive A | −6.5 | 47 | 0.19 |
| Control | 0 | 701.8 | 285 | |
| Additive A | 15 | 644.9 | 150 | |
| | | % Change, | % Reduction, | Bed Volume |
| | Relative to Control | Precipitate Mass | Settling Time | Ratio |
| | 15 mg/L Additive A | −8.1 | 47 | 0.10 |

Precipitate Mass (mg), Settling Time (sec), and Bed Volume Ratio for a Control Test vs. a Clarification Aid Treated Test (mg/L) Using a Synthetic Aqueous Solution.
Solution Composition: Ca²⁺: 2000 mg/L, SO₄²⁻: 4800 mg/L, pH: 2.0 (H₃PO₄).
Additive A is a mixture of phosphonate and polycarboxylate copolymer.

TABLE 2

| | Dosage, mg/L | Precipitate Mass, mg |
|---|---|---|
| Control | 0 | 584.0 |
| Additive A | 0.2 | 586.5 |
| | | % Change, |
| | Relative to Control | Precipitate Mass |
| | 0.2 mg/L Additive A | 0 |
| Control | 0 | 594.6 |
| Additive A | 25 | 355.5 |
| | | % Change, |
| | Relative to Control | Precipitate Mass |
| | 25 mg/L Additive A | −40 |
| Control | 0 | 601.4 |
| Additive A | 50 | 188.3 |
| | | % Change, |
| | Relative to Control | Precipitate Mass |
| | 50 mg/L Additive A | −69 |
| Control | 0 | 591.1 |
| Additive A | 500 | 97.9 |
| | | % Change, |
| | Relative to Control | Precipitate Mass |
| | 500 mg/L Additive A | −83 |

Precipitate Mass (mg) and Settling Time (sec) for Control Tests vs. Clarification Aid Treated Tests (mg/L) Using a Synthetic Aqueous Solution.
Solution Composition: Ca²⁺: 2000 mg/L, SO₄²⁻: 4800 mg/L, pH: 2.0 (H₃PO₄).
Additive A is a mixture of phosphonate and polycarboxylate copolymer.

We claim:

1. A process for modifying the morphology and improving solid-liquid separation of a precipitate in an acid production process comprised of an ore being combined with an acidic solution in a digestion process to react forming an acidic slurry which enters the purification process comprised of passing the acid slurry through a filtration process to form a filtrate which is then passed through an evaporation process and its step of heat exchange and a clarification process, wherein a clarification aid composition is added to the acid slurry and/or filtrate prior to or during the formation of a precipitate in the acid slurry and/or filtrate.

2. The process of claim 1 wherein a polymer flocculant is additionally added with a clarification aid composition.

3. The process of claim 2 wherein the polymer flocculant is in the form of a rapidly inverting emulsion added with no prior treatment to destabilize the emulsion.

4. The process of claim 1 wherein the clarification aid composition is added to the filtrate immediately prior to entering and/or during the evaporation process.

5. The process of claim 1 wherein the clarification aid composition is added to the filtrate immediately prior to entering a heat exchangers.

6. The process of claim 1 wherein the clarification aid composition is added to the filtrate immediately prior to entering a heat exchangers.

7. The process of claim 1 wherein the ore is a phosphate containing ore.

8. The process of claim 5 wherein the phosphate containing ore is beneficiated prior to digestion.

9. The process of claim 5 wherein the acidic solution is sulfuric acid.

10. The process of claim 1 where the clarification aid composition is one or a combination of an organic phosphate, a phosphonate, an inorganic phosphate, a polycarboxylate homopolymer or copolymer, an anionic/cationic polymer mixture.

11. The process of claim 1 where the clarification aid composition is added in substoichiometric amounts.

12. The process of claim 1 where the clarification aid composition is added from 0.1 to 5000 ppm.

13. The process of claim 1 where the clarification aid composition is added from 0.1 to 100 ppm.

14. The process of claim 1 where the clarification aid composition is added from 0.1 to 50 ppm.

15. A process for modifying the morphology and improving solid-liquid separation of a precipitate in an acid production process comprised of an ore being combined with an acidic solution in a digestion process to react forming an acidic slurry which enters the purification process comprised of passing the acid slurry through a filtration process to form a filtrate which is then passed through an evaporation process and its step of heat exchange and a clarification process, wherein a clarification aid composition is added during digestion.

16. The process of claim 15 wherein a polymer flocculant is additionally added with a clarification aid composition.

17. The process of claim 16 wherein the polymer flocculant is in the form of a rapidly inverting emulsion added with no prior treatment to destabilize the emulsion.

18. The process of claim 15 wherein the clarification aid composition is also added to the acid slurry and/or filtrate prior to or during the formation of a precipitate in the acid slurry and/or filtrate throughout the purification process.

19. The process of claim 15 wherein the phosphate containing ore is beneficiated prior to being combined with the acidic solution.

20. The process of claim 15 wherein the acidic solution is sulfuric acid.

21. The process of claim 15 where the clarification aid composition is one or a combination of an organic phosphate, a phosphonate, an inorganic phosphate, a polycarboxylate homopolymer or copolymer, an anionic/cationic polymer mixture.
